(19) United States
(12) Patent Application Publication
(10) Pub. No.: US 2024/0059862 A1
(43) Pub. Date: Feb. 22, 2024

(54) ZEOLITE AVERSIVE ADDITIVE FOR POLYMER COMPOSITIONS AND METHOD OF PREPARING SAME

(71) Applicant: Corning Research & Development Corporation, Corning, NY (US)

(72) Inventors: Linda Sue Baker, Addison, NY (US); Natalya Vyacheslavovna Zaytseva, Painted Post, NY (US)

(21) Appl. No.: 18/370,032

(22) Filed: Sep. 19, 2023

Related U.S. Application Data
(63) Continuation of application No. PCT/US22/18706, filed on Mar. 3, 2022.
(60) Provisional application No. 63/164,256, filed on Mar. 22, 2021.

(51) Int. Cl. C08K 3/34; C08K 3/22; C08K 7/26; C08K 9/04

(52) U.S. Cl. CPC C08K 3/34; C08K 3/22; C08K 7/26; C08K 9/04; C08K 2201/002; C08K 2003/2227; C08K 2201/013

(57) ABSTRACT

Embodiments of the disclosure relate to a polymer composition that includes at least one polymer and an aversive additive dispersed in the at least one polymer. The aversive additive is made of a zeolite material and an aversive material infused within pores of the zeolite material. In embodiments, the aversive additive is incorporated into an optical fiber cable. The optical fiber cable includes at least one optical fiber and a polymeric jacket that surrounds the at least one optical fiber. The polymeric jacket is made of a polymer matrix and the aversive additive is dispersed in the polymer matrix. Embodiments of a method of infusing an aversive material into a zeolite material to form the aversive additive are also disclosed herein.

### CROSS-REFERENCE TO RELATED APPLICATION

This application is a continuation of International Application No. PCT/US2022/018706 filed Mar. 3, 2022, which claims the benefit of priority under 35 U.S.C. § 119 of U.S. Provisional Application No. 63/164,256, filed on Mar. 22, 2021, the content of which is relied upon and incorporated herein by reference in its entirety.

### BACKGROUND

The disclosure relates generally to aversive materials and more particularly to aversive additives for cable jackets. Cables, such as power transmission cables, telephone cables, optical fiber cable, etc., are used to transmit electricity and/or data over distance. In order to do so, the cables have to be strung across land and/or buried in the ground between electricity/data sources and delivery points. Rodents have been known to chew on cables, which damages the cables and which can cause cable failure. Indeed, some estimates attribute approximately 17% of damage to aerial cables to squirrels alone. Other polymer articles are also subject to rodent chewing damage.

### SUMMARY

In one aspect, embodiments of the present disclosure relate to a polymer composition that includes at least one polymer and an aversive additive dispersed in the at least one polymer. The aversive additive is made of a zeolite material and an aversive material infused within pores of the zeolite material.

In another aspect, embodiments of the present disclosure relate to a method in which an aversive material is infused into a zeolite material to form an aversive additive. The zeolite material includes zeolites having an average pore size D₁, and the aversive material includes molecules having a maximum cross-sectional dimension D₂ such that D₂≤D₁≤1.5D₂.

In still another aspect, embodiments of the present disclosure relate to an optical fiber cable. The optical fiber cable includes at least one optical fiber and a polymeric jacket that surrounds the at least one optical fiber. The polymeric jacket is made of a polymer matrix and an aversive additive dispersed in the polymer matrix. The aversive additive includes a zeolite material and an aversive material infused within pores of the zeolite material.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. In the drawings:

FIG. 1 depicts a flow diagram of a method of preparing and deploying an aversive additive, according to an exemplary embodiment;

FIG. 2 depicts a schematic structure of a zeolite Y material, according to an exemplary embodiment;

FIG. 3 is an SEM image of an aversive additive dispersed in a polymer matrix, according to an exemplary embodiment; and

FIG. 4 depicts an optical fiber cable having one or more cable components comprising a polymer composition containing the aversive additive, according to an exemplary embodiment.

### DETAILED DESCRIPTION

Referring generally to the figures, various embodiments of an aversive additive for repelling rodents, birds, insects, monkeys, and other animals from structures made from or including polymers are provided. In many outdoor environments, animals tend to chew, gnaw, climb, or otherwise interact with man-made structures, such as electrical or telecommunication cables, which can cause these structures to prematurely fail, degrade, or be rendered unsuitable for their intended purpose. Aversive materials are used to repel animals before the animals have a chance to injure themselves or to cause damage to the structure. However, in certain circumstances, conventional aversive materials tend to bleed from the matrix in which they are deployed, experience environmental degradation, and/or require reapplication. In contrast, the aversive materials according to embodiments of the present disclosure are infused in a zeolite material, which allows the aversive additive to be compounded at high temperatures with a polymer, to be highly resistant to environmental degradation, to be dispersed evenly throughout the polymer, and to be released upon interaction with an animal. In an embodiment, the aversive additive is incorporated in a polymer composition used, e.g., as a jacket material in an optical fiber cable. These and other embodiments will be described herein and in relation to the figures. Such exemplary embodiments are provided by way of illustration and not by way of limitation.

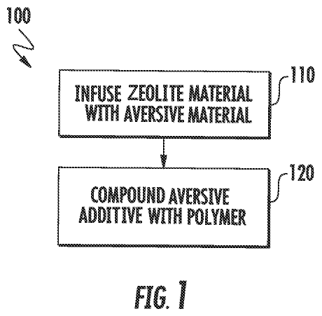

Referring to FIG. 1, a method 100 of preparing a polymer composition containing an aversive additive is provided. Generally, the method 100 of preparing the aversive additive involves a first step 110 of infusing an aversive material into a zeolite material. In embodiments, the zeolite material can be any of a variety of types of zeolites. In embodiments, the zeolite material comprises one or more zeolites selected from the group consisting of zeolite A, zeolite X, zeolite Y, zeolite ZSM, zeolite TZM, zeolite beta, faujasite, clintoplilolite, and mordenite. Further, in embodiments, the zeolite material comprises one or more zeolites ion-exchanged with, e.g., hydrogen, sodium, or ammonium, among other possibilities. In particular embodiments, the zeolite material comprises one or more zeolites selected from the group consisting of zeolite Y, hydrogen; zeolite 13X; zeolite 3A; zeolite 4A; zeolite 5A; and zeolite ZSM-5.

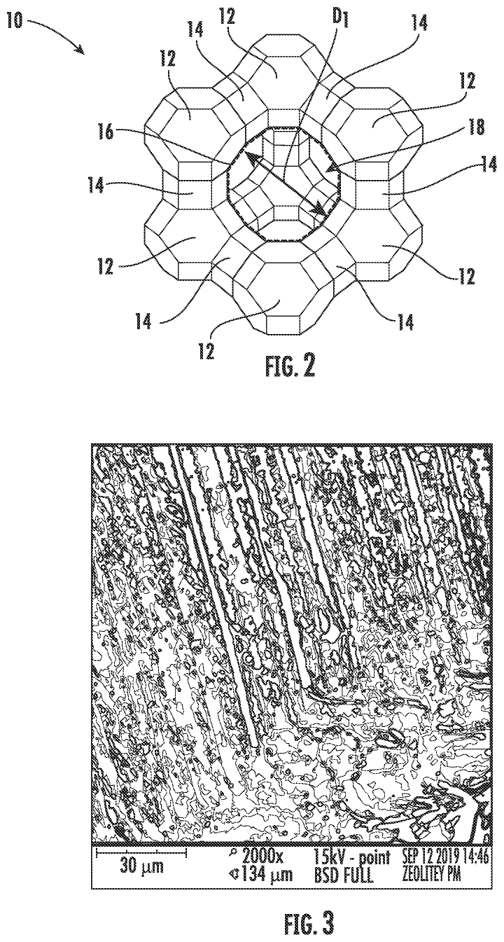

FIG. 2 depicts a schematic representation of a zeolite 10, which is, in particular, zeolite Y. The zeolite 10 includes sodalite cages 12 connected by prisms 14. Depending on the particular structure of the zeolite 10, the prisms 14 may be, e.g., cubic, rectangular, hexagonal, etc. For zeolite Y, the prisms 14 are hexagonal. For type A zeolites, the prisms 14 are cubic. The structure of the sodalite cages 12 and the prisms 14 defines a window or pore 16 having a diameter D₁. As used herein, “diameter” is not meant to imply a circular window or pore 16 but instead refers to a maximum distance between opposing points on the window or pore 16. For the zeolite Y depicted in FIG. 2, the pore 16 is a twelve-ring window. In embodiments, the diameter D₁ is in the range of 3.5 Å to 20 Å. In particular embodiments, the diameter D₁ is in the range of 6.0 Å to 8.0 Å.

Overall, the structure of the sodalite cages 12 arranged at the corners and connected by the prisms 14 defines a supercage structure 18. As disclosed herein, this supercage structure 18 is infused with an aversive material. Advantageously, the high porosity structure of zeolites, including the supercage structure 18, provides the ability to absorb and retain materials in the pores of the zeolite material. In embodiments, the size of the zeolite 10 is configured to tightly fit the molecular size of the aversive material. In embodiments, molecules of the aversive material have a three dimensional shape comprising a maximum cross-sectional dimension D₂. In embodiments, the diameter D₁ of the pore 16 of the zeolite 10 is at least as large as the maximum cross-sectional dimension D₂ of the aversive material molecule. In embodiments, the diameter D₁ is no more than 50% larger than the maximum cross-sectional dimension D₂ of the aversive material molecule (i.e., D₂≤D₁≤1.5D₂). In other embodiments, the diameter D₁ is no more than 25% larger than the maximum cross-sectional dimension D₂ of the aversive material molecule (i.e., D₂≤D₁≤1.25D₂). In still other embodiments, the diameter D₁ is no more than 10% larger than the maximum cross-sectional dimension D₂ of the aversive material molecule (i.e., D₂≤D₁≤1.1D₂).

For example, menthol can be used as an aversive material and has a molecule size (D₂) of about 6 Å. Zeolite Y has a pore size D₁ of about 7.4 Å, and thus, according to embodiments of the present disclosure, the combination of menthol and zeolite Y satisfies one or more of the foregoing relationships (in particular, 7.4/6≤1.25D₂). Other factors may also influence the ability of the supercage structure 18 to hold molecules of aversive material, such as hydrogen bonding, polarity, electronegativity, and Van der Waals forces, among others. In embodiments, these other factors may alternatively or additionally be leveraged to tightly hold molecules of the aversive material in the pores of the zeolite material.

As used herein, an aversive material is one that will repel an animal in the particular environment in which the aversive material is used. Generally, the aversive material will trigger a flavor, olfactory, or tactile response in the animal, repelling the animal from, e.g., chewing, pecking, or climbing on the structure containing the aversive material. In embodiments, the aversive material is an organic material. Examples of suitable organic aversive materials include menthol, cinnamaldehyde, wintergreen oil, capsaicin, peppermint oil, bergamot oil, geranium oil, predator urine, eucalyptus, bitterants, pinene, lemon citrus oil, cedarwood oil, garlic oil, and any other organic aversive materials known in the art to produce an aversive reaction to an animal or animals in any or all environments.

In an embodiment, the step of infusing 110 involves preparing a solution of the aversive material and a solvent. In embodiments, the solution may contain 10:90 to 50:50 ratio of solvent to aversive material. In embodiments, the solvent is used to lower the viscosity of the aversive material so that the solution containing the aversive material can infuse into the pores of the zeolite material. A variety of solvents may be used to form the aversive solution so long as the aversive material is soluble in the solvent. Thereafter, in embodiments, the zeolite material is infused with the aversive solution. In embodiments, the ratio of zeolite material to aversive solution is from 1:2 to 1:20. In embodiments, the mixture of zeolite material and aversive solution is sonicated and placed under vacuum (e.g., 10 inHg to 29.5 inHg) to assist infusion. The mixture may remain under vacuum for a time of 20 minutes to 120 minutes, and the vacuum is slowly released to atmospheric pressure over a time period of, e.g., 30 minutes to 4 hours.

In an experimental embodiment, samples of zeolite Y were infused with a solution of aversive material at 1 part zeolite to 10 parts aversive solution. In a first example embodiment, the zeolite material was infused with peppermint oil, and in another example embodiment, the zeolite material was infused with menthol. The samples were sonicated in the solution and placed in a vacuum desiccator for a time period of over 20 minutes. Vacuum was pulled at 24 inHg. The vacuum was released slowly over 30 minutes to allow infusion of the aversive solution into the pores of the zeolite material. The samples were then centrifuged, the solution was decanted, and the material was rinsed and centrifuged with ethanol, followed by 50:50 ethanol:water, and finally water. The samples were then dried by lyophilization.

Ultra performance liquid chromatography (“UPLC”) (using Waters Acquity H-Class UPLC with PDA detector) was used to confirm and quantify the peppermint oil components of pulegone and menthone infused in the zeolite material. Over a period of 2 to 4 days, 100 mg to 1 g of material was extracted at 40° C. in ethanol. Gas chromatography-mass spectroscopy (“GC-MS”) (using Agilent Technologies 7820A GC System and an Agilent Technologies 5975 Series MSD) method was performed to quantify the menthol infused in the zeolite material.

The maximum concentration of menthone in the first example of infused zeolite Y was 0.884 mg/mL, and the maximum concentration of pulegone in the first example of infused zeolite Y was 0.004 mg/mL. The maximum concentration of menthol in the second example of infused zeolite Y was 17 mg/mL.

After infusing the zeolite material with an aversive material in the first step 110 to form an aversive additive, the aversive additive was then compounded with a polymer in a second step 120. The aversive additive can be compounded with a variety of suitable polymers, including thermoplastic polymers, thermoset polymers, elastomers, and thermoplastic elastomers. Exemplary polymers include ethylene-vinyl acetate copolymers, ethylene-acrylate copolymers, polyethylene homopolymers (low, medium, and high density), linear low density polyethylene, very low density polyethylene, ultra-high molecular weight polyethylene, polypropylene homopolymer, polyolefin elastomer copolymer, polyethylene-polypropylene copolymer, butene- and octane-branched copolymers, or maleic anhydride-grafted versions of the polymers listed above. In another embodiment, exemplary polymers include halogenated thermoplastics (such as polyvinyl chloride); polyamide 6, 6/6, 11, or 12 resins; thermoplastic polyurethane; or a crosslinked polyethylene.

In embodiments, the aversive additive is mixed with other optional polymer additives prior to or during compounding. Typical polymer additives include pigments, stabilizers, fungicides, and fillers. In embodiments, the aversive additive comprises from 1% to 30% by weight of the compounded polymer composition. In further embodiments, the aversive additive comprises from 2% to 25% by weight, or from 5% to 20% by weight, or from 10% to 20% by weight of the compounded polymer composition. In certain embodiments, the aversive additive and other polymer additives together comprise from 2% to 50% by weight of the compounded polymer composition.

In the two example embodiments, the aversive additive was compounded with medium density polyethylene (MDPE). The first example included 10 wt % of the peppermint oil aversive additive in MDPE, and the second example included 20 wt % of the menthol aversive additive in MDPE. Compounding was performed using an 18 mm twin screw extruder (available from Thermo Fisher Scientific Inc., Waltham, MA). The die temperature of the extruder was set to 200° C. The zone temperatures increased from 160° C. to 190° C. Screw speed was set to 150 rpm. No peppermint or menthol odor was detected during compounding and extrusion, and the extruded polymer composition did not exhibit any evidence of outgassing, indicating that the aversive material remained infused in the zeolite during extrusion. FIG. 3 depicts an SEM image of the zeolite Y infused with peppermint oil at 10 wt % in MDPE according to the first example. As can be seen, the infused zeolite aversive additive (white dots) is well-dispersed in the MDPE matrix (gray background).

After compounding, the concentration of the aversive material in the polymer composition was determined. For the first sample, the concentration of peppermint oil components of pulegone and menthone was 0.00011 mg/mL and 0.092 mg/mL, respectively. As compared to the initial concentration prior to compounding of 0.004 mg/mL and 0.884 mg/mL, respectively, UPLC results suggest complete retention of the peppermint oil in the zeolite material during processing as evidenced by the retention of the two components of pulegone and menthone (accounting for the dilution to 10% by weight of the aversive additive during compounding). For the second sample, the concentration of menthol in the MDPE was 6.2 mg/mL as measured by GC-MS, again suggesting complete retention of the menthol in the zeolite material during processing (accounting for the dilution to 20% by weight of the aversive additive during compounding). In one or more embodiments, the initial concentration of aversive material in the polymer composition is up to 10 mg/mL, and in one or more embodiments, the initial concentration of aversive material in the polymer composition is at least 5 mg/mL.

The second example was further subjected to weathering testing according to ASTM G154 cycle 6. This test involves exposing a sample to UVA light at 340 nm and an irradiance of 1.55 W/m²/nm for 8 hours at 60° C. followed by 4 hours without UVA illumination but with condensation at 50° C. These testing effects are cycled for the duration of the test. Four samples of the second example embodiment (menthol infused zeolite Y aversive additive in MDPE) were subjected to weathering tests involving various lengths of exposure to the ambient (laboratory) environment and to the weathering chamber under the conditions of ASTM G154 cycle 6. Table 2, below, provides a breakdown of the exposure for the samples prepared according to the second example embodiment. Table 2 also provides the concentration of aversive material in the polymer composition containing the aversive additive (as measured using GC-MS).

TABLE 2
Weathering conditions for test samples of polymer composition

| Sample | | Concentration |
|---|---|---|
| No. | Timing | (mg/mL) |
| 1 | 12 weeks ambient environment | 5.7 |
| 2 | 6 weeks ambient, 1 week weathering | 6.5 |
| | chamber, 5 weeks ambient | |
| 3 | 6 weeks ambient, 2 weeks weathering | 6.3 |
| | chamber, 4 weeks ambient | |
| 4 | 6 weeks ambient, 3 weeks weathering | 6.9 |
| | chamber, 3 weeks ambient | |

As can be seen from Table 2, the concentration of aversive material in the polymer composition remains substantially the same as the concentration after compounding. According to embodiments of the present disclosure, the polymer composition comprises a first concentration of aversive material after compounding and a second composition of aversive material after a weathering test in ambient conditions and/or according to ASTM G154 cycle 6, and the second concentration is within 20% of the first concentration, in particular within 10%, and most particularly within 5%, as measured using UPLC or GC-MS. In one or more embodiments, the concentration of aversive material in the polymer composition after the weathering test is at least 5 mg/mL.

Advantageously, the zeolite material protects the sensitive organic aversive materials during compounding and extrusion despite exposure to temperatures of greater than 150° C., which might otherwise cause degradation of an unprotected aversive material. In this way, the aversive additive as described herein can be extruded or molded with or otherwise dispersed in a polymer usable in a variety of applications. In some embodiments, the aversive additive described herein is added to a thermoplastic polymer material that is then melted and shaped through extrusion, injection molding, compression molding or any other suitable process to form a polymeric article. In other embodiments, the aversive additive described herein is added to a polymer precursor mixture that is then cured or cross-linked, e.g., via UV, heating, etc., to form a polymeric article.

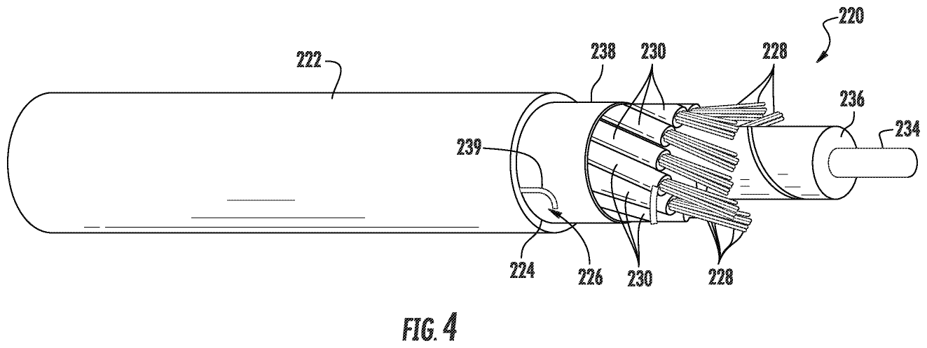

In embodiments, the aversive additive is included in extruded jacketing for cables, such as electrical communication cables, optical communication cables, etc. In a particular embodiment as shown in FIG. 4, the aversive additive is shown as part of an optical fiber cable 220. Cable 220 includes a cable body, shown as polymeric jacket 222, having an inner surface 224 that defines a channel, shown as central bore 226. In embodiments, the polymer jacket 222 is the outermost layer or jacket of the cable 220, making it the first part of the cable 220 exposed to animals. The cable 220 includes a plurality of core elements located within central bore 226. A first type of core element is an optical transmission core element, and these core elements include bundles of optical fibers 228 that are located within tubes, shown as buffer tubes 230. Buffer tubes 230 are arranged around a central support, shown as central strength member 234. Central strength member 234 includes an outer coating layer or upjacket 236. A barrier material, such as water barrier 238, is located around the stranded buffer tubes 230. An easy-access structure, shown as rip cord 239, may be located inside polymeric jacket 222 to facilitate access to buffer tubes 230.

In one embodiment, the aversive additive is incorporated into the polymeric jacket 222 of fiber optic cable 220. In another embodiment, the aversive additive is incorporated into the buffer tubes 230 surrounding the bundles of optical fibers 228. In a further embodiment, the aversive additive is incorporated into the water barrier 238. In still another embodiment, the aversive additive is incorporated into the outer coating layer 236. By extruding a polymer containing the aversive additive around the cable and cable components, the cable 220 is less susceptible to damage from rodents, birds, insects, monkeys, and other animals, and the aversive additive will remain stable in the cable 220 much longer than conventional aversive additives such that reapplication is not required. Moreover, such cables do not need the extensive metal armors that are frequently required in conventional cables to protect against animal-related damage. Dispensing with these metal armors reduces the weight and expense of the cable.

The embodiments of the aversive additive incorporated into the optical fiber cable 220 are provided for the purposes of illustration only and not by way of limitation. Indeed, the aversive additive can be incorporated in many other objects using a polymer as a coating and/or as a component.

Despite being contained and protected, thermally and mechanically, in the zeolite material, the aversive additive as disclosed herein is readily available to dissuade animals from interacting with the polymer composition in which the aversive additive is incorporated. Indeed, the aversive material is released from the zeolite material under bite pressure. Further, the zeolite material itself can act as an aversive material because the zeolite material may cause discomfort when bitten. Moreover, the small particles and/or broken inorganic zeolite material may cause discomfort and may reside in the animal's mouth for a longer period of time, increasing the aversive effect. Notwithstanding, the toxicity of the aversive additive is low despite its overall designed unpleasantness.

Further still, the incorporation of the aversive material in the zeolite material provides processing and deployment advantages. In particular, the aversive material contained in the zeolite material in a stable manner such that it is only released under the pressure of biting, clawing, etc. Accordingly, aversive additives containing a variety of different aversive materials can be prepared and mixed during compounding to provide various desired aversive profiles based on the particular animals and/or geographic regions expected to be encountered. Further, the aversive additives can be incorporated into various mediums that can be used to coat cables in the field, e.g., by spraying or brushing. The aversive additive can also easily be extended to other applications, such as tapes, enclosures, and/or other materials encountered in rodent entry pathways to buildings.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein the article “a” is intended include one or more than one component or element, and is not intended to be construed as meaning only one.

It will be apparent to those skilled in the art that various modifications and variations can be made without departing from the spirit or scope of the disclosed embodiments. Since modifications combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A polymer composition, comprising:
at least one polymer; and
an aversive additive dispersed in the at least one polymer, the aversive additive comprising:
a zeolite material; and
an aversive material infused within pores of the zeolite material.

2. The polymer composition of claim 1, wherein the zeolite material comprises one or more zeolites selected from the group consisting of zeolite A, zeolite X, zeolite Y, zeolite ZSM, zeolite TZM, zeolite beta, faujasite, clintoplilolite, and mordenite.

3. The polymer composition of claim 1, wherein the zeolite material comprises one or more zeolites selected from the group consisting of zeolite Y, hydrogen; zeolite 13X; zeolite 3A; zeolite 4A; zeolite 5A; and zeolite ZSM-5.

4. The polymer composition of claim 1, wherein the zeolite material comprises zeolites having an average pore size D₁ and wherein the average pore size D₁ is from 3.5 Å to 20 Å.

5. The polymer composition of claim 4, wherein the aversive material comprises molecules having a maximum cross-sectional dimension D₂ and wherein D₂≤D₁≤1.5D₂.

6. The polymer composition of claim 1, wherein the zeolite material comprises a first concentration of the aversive material in the polymer composition and wherein, after the polymer composition is subjected to a weathering test according to ASTM G154 cycle 6, the zeolite material comprises a second concentration of the aversive material in the polymer composition that is within 10% of the first concentration of the aversive material.

7. The polymer composition of claim 6, wherein the zeolite material comprises zeolite Y and the aversive material comprises menthol.

8. The polymer composition of claim 7, wherein the first concentration of the aversive material in the polymer composition is from 5 mg/ml to 10 mg/ml.

9. The polymer composition of claim 8, wherein the second concentration of the aversive material in the polymer composition is at least 5 mg/ml.

10. The polymer composition of claim 1, wherein the aversive material is selected from the group consisting of menthol, cinnamaldehyde, wintergreen oil, capsaicin, peppermint oil, bergamot oil, geranium oil, predator urine, eucalyptus, bitterants, pinene, lemon citrus oil, cedarwood oil, garlic oil, and combinations thereof.

11. The polymer composition of claim 1, comprising from 1% to 30%, by weight, of the aversive additive.

12. A method, comprising:
infusing an aversive material into a zeolite material to form an aversive additive, the zeolite material comprising zeolites having an average pore size D₁ and the aversive material comprising molecules having a maximum cross-sectional dimension D₂, wherein D₂≤D₁≤1.5D₂.

13. The method of claim 12, wherein the step of infusing comprises subjecting a mixture of the zeolite material and a solution containing the aversive material to a vacuum pressure in a range of 10 inHg to 29.5 inHg and releasing the vacuum pressure to atmospheric pressure over a time period of at least 30 minutes so as to allow the solution containing the aversive material to infuse into pores of the zeolite material.

14. The method of claim 12, wherein the zeolite material comprises one or more zeolites selected from the group consisting of zeolite A, zeolite X, zeolite Y, zeolite ZSM, zeolite TZM, zeolite beta, faujasite, clintoplilolite, and mordenite.

15. The method of claim 12, wherein the zeolite material comprises one or more zeolites selected from the group consisting of zeolite Y, hydrogen; zeolite 13X; zeolite 3A; zeolite 4A; zeolite 5A; and zeolite ZSM-5.

16. The method of claim 12, wherein the aversive material is selected from the group consisting of menthol, cinnamaldehyde, wintergreen oil, capsaicin, peppermint oil, bergamot oil, geranium oil, predator urine, eucalyptus, bitterants, pinene, lemon citrus oil, cedarwood oil, garlic oil, and combinations thereof.

17. The method of claim 12, further comprising the step of compounding the aversive additive with a polymer to form a polymer composition, wherein the aversive additive comprises from 1% to 30% by weight of the polymer composition.

18. The method of claim 17, further comprising the step of extruding the polymer composition at a temperature of at least 150° C.

19. The method of claim 12, wherein infusing provides a concentration of aversive material in the zeolite material in a range of 5 mg/ml to 10 mg/ml.

20. An optical fiber cable, comprising:
at least one optical fiber; and
a polymeric jacket that surrounds the at least one optical fiber;
wherein the polymeric jacket comprises:
a polymer matrix; and
an aversive additive dispersed in the polymer matrix, the aversive additive comprising:
a zeolite material; and
an aversive material infused within pores of the zeolite material.

21. The optical fiber cable of claim 20, wherein the zeolite material comprises a first concentration of the aversive material and wherein, after the polymeric jacket is subjected to a weathering test according to ASTM G154 cycle 6, the zeolite material comprises a second concentration of the aversive material that is within 10% of the first concentration of the aversive material.

22. The optical fiber cable of claim 21, wherein the first concentration of the aversive material in the zeolite material is from 5 mg/ml to 10 mg/ml.

23. The optical fiber cable of claim 20, wherein the aversive material is selected from the group consisting of menthol, cinnamaldehyde, wintergreen oil, capsaicin, peppermint oil, bergamot oil, geranium oil, predator urine, eucalyptus, bitterants, pinene, lemon citrus oil, cedarwood oil, garlic oil, and combinations thereof.

24. The optical fiber cable of claim 20, wherein the zeolite material comprises one or more zeolites selected from the group consisting of zeolite A, zeolite X, zeolite Y, zeolite ZSM, zeolite TZM, zeolite beta, faujasite, clintoplilolite, and mordenite.

25. The optical fiber cable of claim 20, wherein the polymeric jacket is an outermost jacket of the optical fiber cable.
